(19) United States
(12) Patent Application Publication
(10) Pub. No.: US 2016/0136651 A1
(43) Pub. Date: May 19, 2016

(54) APPARATUS AND METHODS FOR REMOVING BLOCKAGES IN A SHREDDING APPARATUS

(71) Applicant: National Conveyors Company, Inc., East Granby, CT (US)

(72) Inventors: Arnold B. Serenkin, Granby, CT (US); Brian L. Smith, North Granby, CT (US); Darryl M. Beech, Belchertown, MA (US)

(21) Appl. No.: 14/543,042

(22) Filed: Nov. 17, 2014

(51) Int. Cl. B02C 18/16; B02C 18/18; B02C 18/06

(52) U.S. Cl. CPC B02C 18/16; B02C 18/062; B02C 18/182; B02C 2018/164

(57) ABSTRACT

Apparatus and methods are discussed herein for safely and automatically removing blockages from a shredding apparatus. For example, the shredding apparatus discussed herein include features that force blockages out of the shredding apparatus while the shredding apparatus is operating in one direction, without hindering the shredding of materials when the shredding apparatus is operating in an opposite direction. Moreover, the features remain stationary irrespective of the direction at which the shredding apparatus is operating, reducing the risk of failure.

### BACKGROUND OF THE INVENTION

This invention relates to industrial shredders. More particularly, this invention relates to clearing blockages from such shredders.

Industrial shredders can reduce solid industrial waste, such as metallic waste (e.g., lathe turnings), into smaller pieces for easier disposal or transport (e.g., to a recycling facility). However, occasionally, a larger piece of the material to be shredded will be encountered which cannot be shredded, and blocks or jams the shredding mechanism. Such larger pieces will be referred to herein as “blockages.”

Known industrial shredders can detect blockages (based, e.g., on lack of motion in the shredding mechanism, or on higher motor current), and switch to a reject mode in which the blockage is directed to a reject outlet. However, in known reject arrangements, the reject outlet is in the working area of the shredder and allows unrejected material to enter along with the rejected blockage, unless equipped with a door that opens only in the reject mode (which requires a door control mechanism).

### SUMMARY OF THE INVENTION

Accordingly, apparatus and methods are discussed herein for safely and automatically removing blockages from a shredding apparatus. Moreover, in addition to allowing blockages to safely and automatically be removed from the shredding apparatus, the shredding apparatus features a design that limits the need for excess moving parts (e.g., door control mechanisms) and streamlines the removal of blockages. For example, the shredding apparatus discussed herein includes features that force blockages out of the shredding apparatus while the shredding apparatus is operating in one direction, without hindering the shredding of materials when the shredding apparatus is operating in an opposite direction. Moreover, the features remain stationary irrespective of the direction in which the shredding apparatus is operating, reducing the risk of failure.

In some aspects, the shredding apparatus may include a first carrier movable in a first direction and a second direction, in which the second direction is opposite to the first direction. For example, the first carrier may be a plate that rotates around an axis, or may be a chain or belt that advances along a particular route.

The shredding apparatus may also include a first tooth extending from an edge of the first carrier, in which a first face of the first tooth shreds material when the first carrier is moving in the first direction and a second face of the first tooth pushes a blockage when the first carrier is moving in the second direction. For example, the same tooth that is used for shredding material when the shredding apparatus is operating in the first direction may be used to expel a blockage when the shredding apparatus is operating in the second direction. In some embodiments, the first carrier may include a plurality of teeth.

The shredding apparatus may also include a first finger, in which the first finger interacts with the blockage to move the blockage from the first tooth as the first tooth passes the first finger in the second direction. For example, the tooth may push the blockage until the blockage contacts the first finger. The contact with the first finger may then cause the blockage to move away from the tooth. For example, in response to the blockage contacting the first finger as the first carrier is moving in the second direction, the second face may advance the blockage in a direction other than the second direction.

In some embodiments, the shredding apparatus may include a second carrier, and the second carrier may include a second tooth extending from an edge of the second carrier, in which the second tooth and the first tooth move along respective parallel paths. For example, the shredding apparatus may include a plurality of carriers arranged in a row and/or sharing a common axis such that the motion of a tooth on each carrier parallels the motion of a tooth on another carrier.

In some embodiments, a second tooth on a second carrier may have a position along its respective path that is offset from a position of the first tooth on the first carrier along its respective path. For example, the teeth on a carrier may be staggered respective to the teeth on a different carrier such that different teeth are interacting with the same portion of the material and/or blockage at different times. Alternatively, the second tooth on the second carrier may have a position along its respective path that is aligned with a position of the first tooth on the first carrier along its respective path. For example, the teeth on a carrier may be aligned with the teeth on a different carrier such that different teeth are interacting with the same portion of the material and/or blockage simultaneously.

In some embodiments, the shredding apparatus may include a second finger, in which the second finger and the first finger are arranged in a row, and wherein at least one of the first finger or the second finger interacts with the blockage to move the blockage from the first tooth. For example, the first and second fingers may be a part of a comb, which features a plurality of fingers, and the path of a tooth may take the tooth between a pair of fingers in the plurality of fingers. Furthermore, the tooth may be sized such that while it may clear the space between the plurality of fingers, a blockage pushed by the tooth may not. Accordingly, as the blockage cannot be pushed between the plurality of fingers, the pushing of the tooth may force the blockage to ride up the surface of the fingers.

A first portion of a tooth (e.g., a portion of the tooth further from the carrier) may push the blockage as a second portion of the tooth (e.g., a portion of the tooth closer to the carrier) passes between the first finger and the second finger as the first carrier is moving in the second direction. For example, as the tooth moves between the plurality of fingers, the tooth may continue to push the blockage (e.g., which may already be positioned on top of the plurality of fingers due to the initial contact between the pushed blockage and the plurality of fingers). Furthermore, the continued pushing may advance the blockage along the plurality of fingers, increasing the distance between the blockage and the carrier.

In some embodiments, the faces of a tooth may have specialized contours. For example, the second face may be contoured to positively engage the blockage. Such a contour may enhance the ability of the tooth to push a blockage and direct the blockage in a particular direction. For example, the contour may create a surface that prevents the blockage from moving in a direction oblique to the direction of motion of the carrier prior to the blockage contacting a finger.

The shredding apparatus may include a rejection passage for expelling the blockage from the shredding apparatus. For example, the blockage may pass into the rejection passage after the first finger moves the blockage from the first tooth. After the blockage passes into the rejection passage, which may constitute an opening in the shredding apparatus, gravity may cause the blockage to fall, removing it from the shredding apparatus. In some embodiments, the rejection passage may be accessible to the material while the first carrier moves in the first direction (i.e., the rejection passage may remain open even while material is being shredded by the shredding apparatus, as long as the opening of the rejection passage is far enough from the carrier that material being fed into the shredding apparatus will not enter the rejection passage while the shredding apparatus is operating in the first direction). In contrast, when the shredding apparatus is operating in the second direction, the second face of a tooth may force the blockage towards the rejection passage (e.g., along the finger, which may also function as a ramp).

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an isometric view of a shredding apparatus in accordance with some embodiments of the invention;

FIG. 2 shows a blockage that has been pushed into a rejection passage by a shredding apparatus in accordance with some embodiments of the invention;

FIG. 3 is an illustrative example of a carrier in accordance with some embodiments of the invention;

FIG. 4 shows an illustrative cross-section of a shredding apparatus in accordance with some embodiments of the invention;

FIG. 5 shows another illustrative cross-section of a shredding apparatus in which a blockage prevents the shredder from moving in a first direction in accordance with some embodiments of the invention;

FIG. 6 shows another illustrative cross-section of a shredding apparatus in which the shredding apparatus has pushed a blockage in a second direction in accordance with some embodiments of the invention;

FIG. 7 shows another illustrative cross-section of the shredding apparatus in which the shredding apparatus has pushed a blockage onto a finger in accordance with some embodiments of the invention;

FIG. 8 shows another illustrative cross-section of the shredding apparatus in which the shredding apparatus has pushed a blockage into a rejection passage in accordance with some embodiments of the invention; and

FIG. 9 shows an illustrative example of a blockage being pushed into a rejection passage from a point of view inside the rejection passage in accordance with some embodiments of the invention;

FIG. 10 shows an illustrative example of a control system used to detect a blockage in the shredding apparatus in accordance with some embodiments of the invention; and

FIG. 11 shows an illustrative example of a shredding apparatus featuring a chain or belt used as a carrier in accordance with some embodiments of the invention.

### DETAILED DESCRIPTION OF THE DRAWINGS

Apparatus and methods are discussed herein for safely and automatically removing blockages from a shredding apparatus. Moreover, in addition to allowing blockages to safely and automatically be removed from the shredding apparatus, the apparatus and methods limit the need for excess moving parts and streamlines the removal of blockages. For example, the shredding apparatus discussed herein includes features that force blockages out of the shredding apparatus while the shredding apparatus is operating in one direction, without hindering the shredding of materials when the shredding apparatus is operating in an opposite direction. Moreover, the features remain stationary irrespective of the direction at which the shredding apparatus is operating, reducing the risk of failure.

As referred to herein, “a shedding apparatus” is any apparatus used for shredding material. As referred to herein, “shredding” includes any technique for reducing the size of materials through physical changes to the form of the materials. For example, shredding may include cutting, ripping, grinding, compressing, tearing, crushing, and/or any other physical reactions. The shredding apparatus may reduce the size of various, and is not limited to any particular, materials, types of materials, and/or combinations of materials. For example, the shredding apparatus may shred metals, wood, plastics, organics, etc., or combinations thereof. Finally, material may be inputted into the shredding apparatus through a variety of techniques and is not limited to any particular technique. For example, materials (e.g., machine shop turnings) may be fed into the shredding apparatus via a conveyor belt (e.g., a chip conveyor of a machine tool), manual loading by a user, an output of an adjacent machine, etc.

In some cases, material fed into the shredding apparatus may create a blockage that prevents or impairs the shredding apparatus from operating in a direction associated with shredding materials. For example, the size or hardness of a portion of the material may cause that portion to clog the shredding apparatus, reducing the efficiency of the shredding apparatus or causing the shredding apparatus to cease to operate. For a more specific example, if the material includes machine shop turnings, another object (e.g., a screw, bolt, etc.) may be mixed into the turnings that are fed into the shredding apparatus. The object may be too large for the shredding apparatus to shred and, in turn, may prevent one or more carriers from moving.

The shredding apparatus may include one or more carriers that move in one or more directions within a housing. As referred to herein, “a carrier” refers to any component from which a shredding tooth may extend, and which may be moved in a first direction to shred material and in a second direction to expel blockages. For example, a carrier may include a circular plate that is rotatable in one direction around an axis to shred material, and rotatable in an opposite direction around the axis to expel blockages. In another example, a carrier may include a chain or belt that may be advanced in a first direction to shred material and advanced in a second direction to expel blockages.

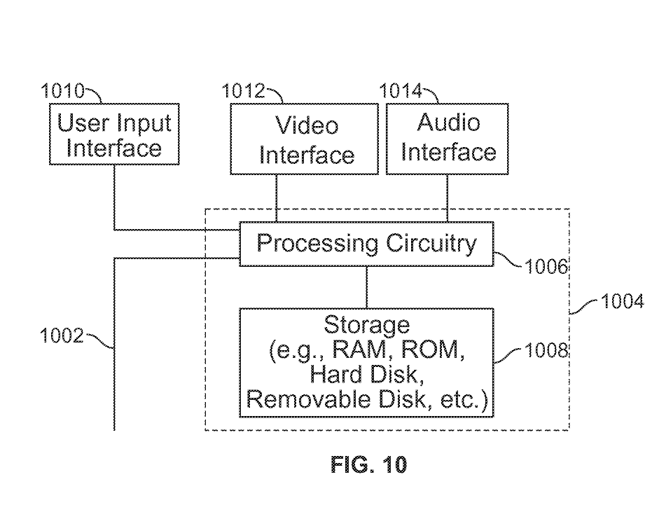

In response to detecting a blockage that prevents the first carrier from moving in the first direction, the shredding apparatus may move the first carrier in a second direction. For example, if a blockage in the shredding apparatus causes motion of the carrier in one direction to stop or the shredding apparatus ceases to operate in one direction (e.g., the shredding apparatus becomes jammed), the shredding apparatus may reverse its direction of operation in order to expel the blockage. Blockages may be detected by operator inspections, or the shredding apparatus may automatically detect blockages as discussed below in relation to FIG. 10.

As referred to herein, “a tooth” is an any extension from a carrier that shreds material when the carrier is moving in a first direction and pushes a blockage when the carrier is moving in a second direction. A tooth is not limited to any particular shape or size. For example, a tooth may have a cubic, triangular, spherical, or other shape. Moreover, the edges of a tooth may be defined by lines and/or curves extending in various directions at various angles. For example, a tooth may extend at an angle that is greater than zero and less than ninety degrees. Additionally or alternatively, a tooth may extend at an angle that is greater than ninety degrees and less than one-hundred and eighty degrees. Furthermore, the angle or degree of curvature of the edge may change along the edge.

The angle or curvature of the edge may result in a face of the tooth having a contour. As referred to herein, “a face” is a surface of the tooth that interacts with material/blockages. The tooth may include multiple defined faces (e.g., as found in a cubic tooth) or may include less-defined faces (e.g., as found in a spherical tooth). For example, a single tooth may have multiple faces, each of which has a distinct contour and size. In another example, a single tooth may include multiple faces, each of which has a similar contour and size. For example, a tooth may include a face that contacts material/blockages when the carrier is moving in a one direction and a different a face that contacts material/blockages when the carrier is moving in an opposite direction.

A face may be contoured to positively engage the blockage. Such a contour may enhance the ability of the tooth to push a blockage and direct the blockage in a particular direction. For example, the contour may create a surface that prevents the blockage from moving in a direction oblique to the second direction prior to the blockage contacting a finger. For example, the face of a tooth may be contoured to angle or curve towards the carrier from which the tooth extends such that the contoured face may better grip the blockage as the face moves the blockage.

In some embodiments, a face of a tooth may be contoured based on whether the face of the tooth is used for shredding material or pushing blockages. For example, the shredding apparatus may include a first tooth extending from an edge of the first carrier, in which a first face of the first tooth shreds material when the first carrier is moving in the first direction, and in which a second face of the first tooth pushes a blockage when the first carrier is moving in the second direction. Accordingly, the first face may be contoured for shredding material while the second face is contoured for pushing blockages. For example, a first face (e.g., used to shred material) may be serrated, whereas a second face (e.g., used to push blockages) may be smooth.

In some embodiments, the shredding apparatus may include a plurality of teeth on one or more carriers. For example, the plurality of teeth may be arranged such that each of the plurality of teeth shreds material or pushes blockages in series or parallel. For example, the plurality of teeth may be arranged on a single carrier (e.g., to interact with a blockage in series) or distributed across multiple carriers (e.g., to interact with the blockage in series or in parallel). For example, the shredding apparatus may push the blockage along the first finger with a first tooth of a first carrier as the first tooth passes the first finger in the second direction, and then push the blockage along the first finger with a second tooth of the first carrier after the first tooth passes the first finger in the second direction. Alternatively or additionally, the shredding apparatus may push the blockage along the first finger with a first tooth of a first carrier as the first tooth passes the first finger in the second direction, and then push the blockage along the first finger with a second tooth of a second carrier after the first tooth passes the first finger in the second direction.

Each carrier of the plurality of carriers may include one or more teeth, which may be angularly aligned or offset with the plurality of teeth on an adjacent carrier. For example, the position of a first tooth on a first carrier may be rotated in the second direction a particular number of degrees relative to the position of a second tooth on a second carrier. Accordingly, a second tooth on a second carrier may have a position along its respective path that is offset from a position of the first tooth on the first carrier along its respective path (e.g., parallel to the path of the second tooth). By staggering the teeth on different carriers, or arranging the teeth in different patterns as discussed below, the shredding apparatus causes different teeth to interact with different portions of the material and/or blockage at different times. Alternatively, the shredding apparatus may align the teeth of different carriers. For example, the second tooth on the second carrier may have a position along its respective path that is aligned with a position of the first tooth on the first carrier along its respective path. By aligning the teeth on different carriers, the shredding apparatus causes different teeth to interact with different portions of the material and/or blockage simultaneously.

In some embodiments, the plurality of teeth on the one or more carriers may be arranged in a pattern associated with a particular function. For example, one pattern of teeth may shred the material from the carriers on the ends of the plurality of carriers inward towards the center of the plurality of carriers. In such a pattern, a tooth on a more-centrally located of the plurality of carriers is held back (e.g., by sixty degrees) in the direction of shredding relative to an adjacent, less-centrally located carrier. Another pattern of teeth may shred the material from one end of the plurality of carriers towards the opposite end of the plurality of carriers. In such a pattern, a tooth located on one end of the plurality of carriers is advanced (e.g., by sixty degrees) in the direction of shredding relative to an adjacent carrier that is closer to the opposing end. Another pattern of teeth may shred the material from a center of the plurality of carriers towards the ends of the plurality of carriers. In such a pattern, a tooth on a more-centrally located of the plurality of carriers is advanced (e.g., by sixty degrees) in the direction of shredding relative to an adjacent, less-centrally located carrier. Furthermore, each pattern may direct shredded material downward to a discharge outlet.

The shredding apparatus may also include one or more fingers. As referred to herein, “a finger” is a projection in the housing of the shredding apparatus that interacts with blockages pushed by a tooth to move the blockage away from the tooth when the shredding apparatus is operating in a second direction, but that does not interfere with the shredding of material when the shredding apparatus is operating in the first direction. For example, a finger may include a projection of a comb, in which the finger is one of a plurality of fingers aligned in a row that are sized to allow a tooth to move freely between the plurality of fingers when moving in the first or second direction. In some embodiments, the comb and/or the plurality of fingers may be aligned in a row that is parallel to an axis about which a carrier rotates.

For example, in some embodiments, the shredding apparatus may pass a tooth between a first finger and a second finger. Furthermore, dimensions of the tooth and the dimensions of a plurality of fingers may be selected such that a tooth may clear the space between the plurality of fingers, while a blockage pushed by the tooth may not. For example, the width of a tooth may correspond to the width of a gap between two fingers and the width of a finger may correspond to the width of a gap between two teeth on adjacent carriers.

In some embodiments, a finger interacts with a blockage to move the blockage from the first tooth as a tooth passes the finger in the second direction. For example, the tooth may push the blockage until the blockage contacts the finger. The contact with the finger may then cause the blockage to move away from the tooth. For example, in response to the blockage contacting the finger as a carrier from which the tooth extends is moving in the second direction, the interaction between the tooth, blockage, and finger may advance the blockage in a direction other than the second direction.

The shredding apparatus may include a rejection passage for expelling the blockage from the shredding apparatus. As referred to herein, “a rejection passage” is any aperture that allows for a blockage to exit the housing of the shredding apparatus. For example, the blockage may pass into the rejection passage after the first finger moves the blockage from the first tooth. After passing into the rejection passage, the blockage may be removed from the shredding apparatus via gravity, user interaction, a conveyor belt, etc.

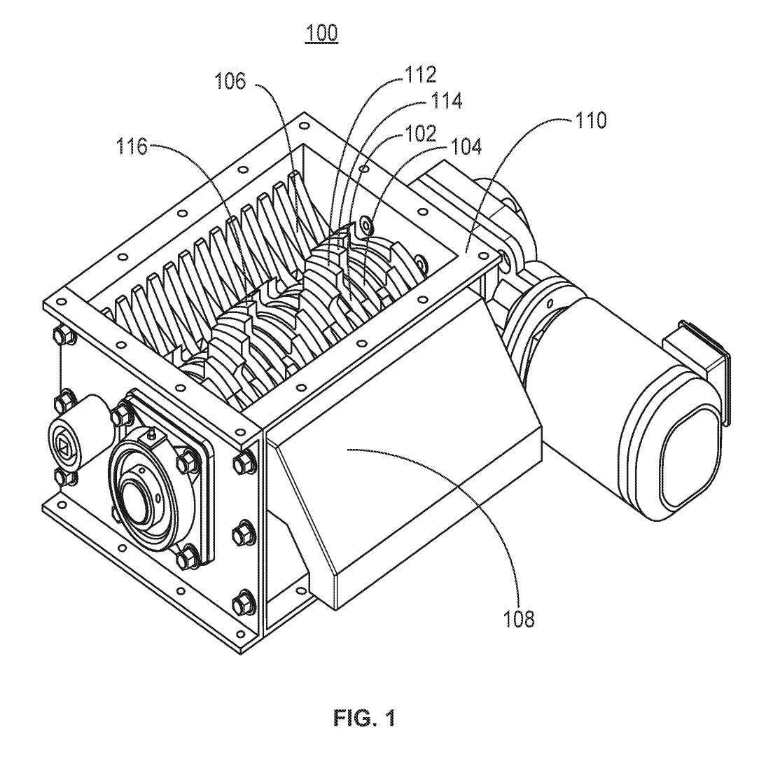

FIG. 1 shows an isometric view of shredding apparatus 100, in which the top of shredding apparatus 100 and two sides are shown. Shredding apparatus 100 includes numerous features for shredding material as well as safely and automatically removing blockages. For example, shredding apparatus 100 includes housing 110, which houses a plurality of carriers (e.g., carrier 102 and carrier 104) and a plurality of cutting members (e.g., cutting member 106). In FIG. 1, the plurality of carriers are arranged in a row and rotate about a common axis. The plurality of cutting members are also arranged in a row that is parallel to the row of plurality of carriers. It should be noted that, in some embodiments, the plurality of carriers arranged in a row may include one or more belts, chains, or other members that may be moved by shredding apparatus 100 in one or more directions.

As shown in FIG. 1, the top of housing 110 is open to allow materials to fall or otherwise be moved towards the plurality of carriers and cutting members. During operation, shredding apparatus 100 may move the plurality of carriers in a direction (e.g., around an axis) such that teeth located on the plurality of carriers move the material towards the plurality of cutting members. As the shredding apparatus moves the plurality of carriers, the teeth pushing the material will pin the material between a face of a tooth and a cutting member of the plurality of cutting members.

A portion of the shredded material (e.g., now shredded to a size that may pass under and between the plurality of carriers) will continue to be pushed towards a discharge outlet (not shown) on the bottom of shredding apparatus 100. The portion of the shredded material that was not moved by the tooth under and between the plurality of cutting members will remain above the plurality of cutting members. As the plurality of carriers continues to move (e.g., rotates around an axis), the teeth extending from the carrier will engage the portion of the shredded material that was not moved by the tooth under and between the plurality of cutting members during one or more subsequent passes. For example, as shredding apparatus 100 moves the plurality of carriers, the material may be shredding in one or more iterations. During each iteration, a portion of the shredded material is moved towards the discharge outlet. Material that is not moved towards the discharge outlet is then moved towards the discharge outlet during a subsequent iteration.

For example, shredding apparatus 100 may be positioned adjacent to a conveyor. The conveyor may act to feed material (e.g., machine tool turnings) into the top of housing 110. As the material is fed into the shredding apparatus, the plurality of carriers (e.g., carrier 102 and carrier 104) and the plurality of cutting members (e.g., cutting member 106) may shred the material during one or more iterations. The shredded material may exit the shredding apparatus through the discharge outlet.

While operating, shredding apparatus 100 may detect a blockage (e.g., as discussed below in relation to FIG. 10). In response, shredding apparatus 100 may reverse the direction at which the plurality of carriers moves in order to expel the blockage. For example, shredding apparatus 100 may cause the plurality of carriers, previously moving in a first direction, to move in a second direction. As the plurality of carriers (e.g., carrier 102 and carrier 104) are moving in the opposite direction, the teeth (e.g., tooth 112 and tooth 114) extending from each of the plurality of carriers may also move in the opposite direction. Furthermore, while the teeth are moving in an opposite direction, the teeth may push the blockage in the opposite direction towards rejection passage 108. Rejection passage 108 may be an aperture in housing 110 that allows blockages to be pushed out of shredding apparatus 100. For example, upon entering rejection passage 108, the blockage may fall, or may be otherwise moved, away from shredding apparatus 100.

Tooth 112 on carrier 102 is staggered respective to tooth 114 on carrier 104. Accordingly, tooth 112 and tooth 114 may interact with different portions of the material and/or blockage at different times while shredding apparatus 100 is operating. In contrast, tooth 116 is positioned along its respective path such that it is aligned with a position of tooth 114 on along its respective path. Accordingly, tooth 114 and tooth 116 may interact with different portions of the material and/or blockage at simultaneously while shredding apparatus 100 is operating.

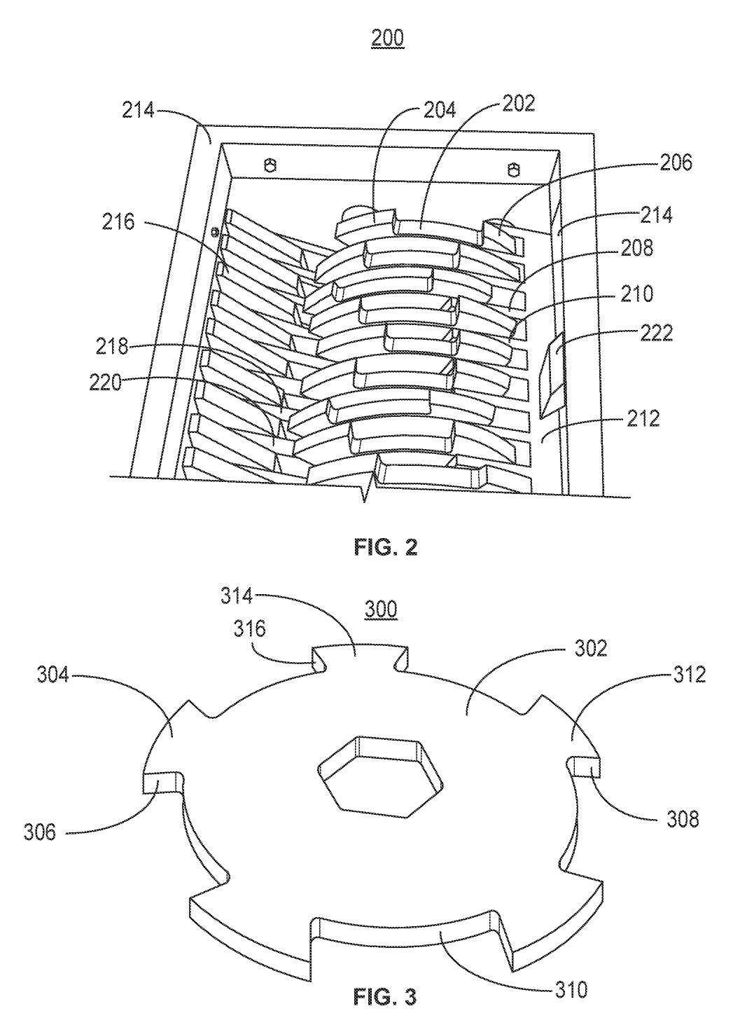

FIG. 2 shows a blockage that has been pushed into a rejection passage by a shredding apparatus. In particular, FIG. 2 shows a top-down view of shredding apparatus 200. Shredding apparatus 200 includes carrier 202 (which in some embodiments may correspond to carrier 102 (FIG. 1) or carrier 104 (FIG. 1)) among a plurality of carriers along a common axis. The plurality of carriers each include one or more teeth (e.g., tooth 204 and tooth 206) extending from the edge of a respective carrier (e.g., tooth 204 extends from carrier 202). As shown in FIG. 2, each tooth of the plurality of teeth extends from the carrier in a direction perpendicular to a common axis about which each of the plurality of carriers rotates.

Shredding apparatus 200 also includes a plurality of cutting members such as cutting member 216 and cutting member 218. As the plurality of carriers of shredding apparatus 200 move in a first direction, the plurality of carriers may cause one or more teeth on the plurality of carriers to push material towards the plurality of cutting members. Upon contacting the plurality of cutting members, the plurality of cutting members may apply a force, opposite of the force applied by a tooth extending from one of the plurality of carriers, to the material. The opposing forces cause the material to be shred. For example, the plurality of cutting members are sized such that the teeth extending from the plurality of carriers may pass under and/or between each of the cutting members. However, material which does not share the dimensions of the tooth (e.g., material which is larger that a face of the tooth in the first direction) may be pinned between a tooth and a cutting member. For example, material that extends beyond the bounds of a face in a direction parallel to the axis of the plurality of carriers (e.g., a face of the tooth that interacts with the material as the tooth moves in the first direction) may encounter a cutting member such as cutting member 218, whereas material that extends beyond the bounds of the face in a direction perpendicular to the axis of the plurality of carriers may encounter a cutting member such as cutting member 216. Cutting member 218 may apply a force to the material as the tooth passes between cutting member 218 and an adjacent cutting member (e.g., cutting member 220). Likewise, cutting member 216 may apply a force to the material as the tooth passes under cutting member 216. By applying the opposing forces to the material, shredding apparatus 200 shreds the material.

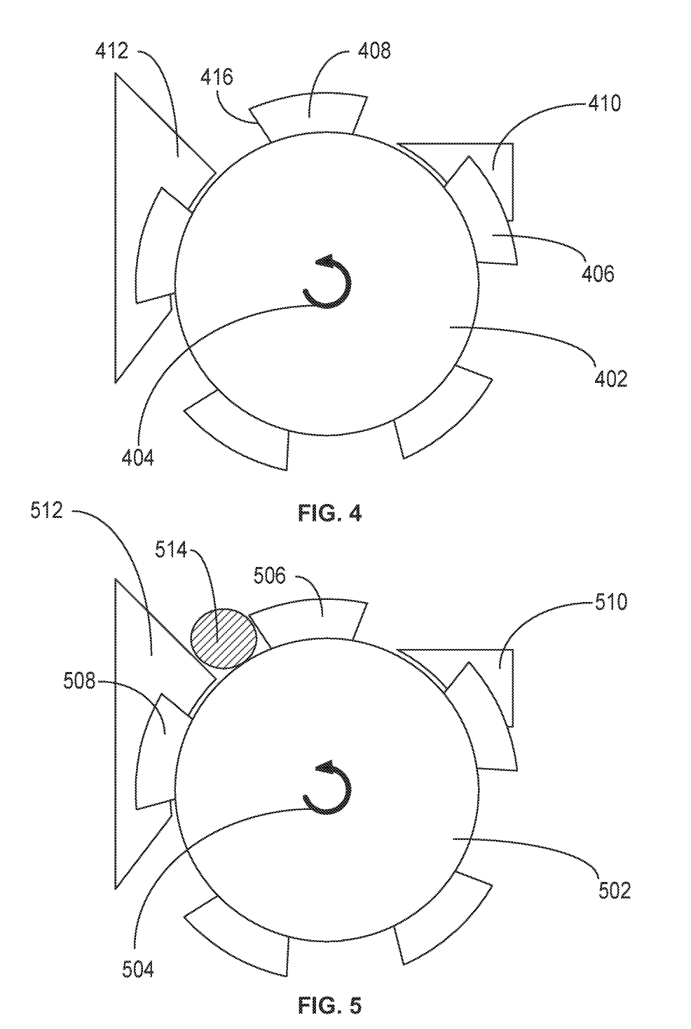

Shredding apparatus 200 also includes comb 212 which lies between a rejection passage 214 (which, in some embodiments, may correspond to rejection passage 108 (FIG. 1) and the plurality of carriers. For example, comb 212 includes a plurality of fingers (e.g., finger 208 and finger 210) extending from the comb in a direction away from rejection passage 214. Each of the plurality of fingers is sized such that teeth on a carrier may pass between two adjacent fingers (e.g., finger 208 and finger 210) and under comb 212; however, blockages, pushed by the teeth, are moved on top of one or more of the fingers (e.g., as discussed below in relation to FIGS. 4-8). After moving onto one or more of the fingers, one or more of the plurality of teeth continue to push the blockage toward rejection passage 214 (e.g., as discussed below in relation to FIGS. 4-8). It should be noted that in some embodiments, comb 212 may also create an incline over which blockages must be pushed before entering rejection passage 214.

For example, shredding apparatus 200 has pushed blockage 222 across one or more of the plurality of fingers (e.g., finger 208 and finger 210) and comb 212 and into rejection passage 214. Blockage 222 is currently being pushed over the precipice of rejection passage 214. Accordingly, gravity or pushing by a tooth or another blockage may cause blockage 222 to enter rejection passage 214 and exit housing 214.

In some embodiments, rejection passage 214 may be accessible to the material while shredding apparatus 200 operates in a direction associated with shredding material. For example, rejection passage 214 may remain open even while material is being shredded by shredding apparatus 200 without a substantial amount of material entering rejection passage 214 because rejection passage 214 is positioned at a distance from carrier 202. To bridge the distance, material needs to be pushed across the plurality of fingers (e.g., finger 208 and finger 210) and comb 212. However, shredding apparatus 200 will only push material (e.g., blockages) across the plurality of fingers (e.g., finger 208 and finger 210) and comb 212 while operating in a direction to remove blockages (i.e., a direction opposite of the direction associated with shredding material).

FIG. 3 is an illustrative example of a carrier. For example, in some embodiments, carrier 300 may constitute one of the plurality of carriers discussed above in relation to FIG. 1 (e.g., carrier 102 or carrier 104) and FIG. 2 (e.g., carrier 202). In FIG. 3, carrier 300 is shaped as a plate. Furthermore, carrier 300 includes an aperture through which carrier 300 may be placed on an axis. For example, as described in relation to FIGS. 1-2 above, carriers such as carrier 300 may be positioned in a row with other carriers within a housing (e.g., housing 214 (FIG. 2)) of a shredding apparatus (e.g., shredding apparatus 100 (FIG. 1)). Each of the carriers, such as carrier 300, may rotate about the axis in a first direction in order to shred material and a second direction in order to expel blockages from a shredding apparatus.

Carrier 300 includes five teeth that extend from edge 310. Each of five teeth (e.g., tooth 304) have identical dimensions and are evenly distributed about the perimeter of carrier 300. Furthermore, each tooth (e.g., tooth 304) includes a first face (e.g., face 306) that interacts with material when carrier 300 is moving in a first direction and a second face (e.g., face 308) that interacts with blockage with carrier 300 is moving in a second direction. It should be noted that, in some embodiments, carrier 300 may include more or less than five teeth, and each of the teeth may not include identical dimensions and may not be evenly distributed about the perimeter of carrier 300.

Tooth 304 extends from edge 310 of carrier 300. As shown in FIG. 3, the width of tooth 304 (in a plane perpendicular to an axis of carrier 300) enlarges as tooth 304 extends outward from the carrier. As the portion of tooth 304 further from carrier 300 is wider than the portion of tooth 304 closer to carrier 300, face 306 of tooth 304 is contoured to positively engage material/blockages as carrier 300 moves in a first direction. Likewise, as the portion of tooth 312 further from carrier 300 is wider than the portion of tooth 312 closer to carrier 300, face 308 of tooth 312 is contoured to positively engage material/blockages as carrier 300 moves in the second direction, opposite to the first.

In some embodiments, while the profile of each of the teeth extending from carrier 300 in a direction perpendicular to the axis may vary, the maximum distance each of the teeth extends outward from the center point of carrier 300 may be identical. For example, the maximum distance that each of the teeth extending outward from the center point of carrier 300 may correspond to the maximum size of a tooth that allows the tooth to pass under a cutting member (e.g., cutting member 216 (FIG. 2)) and/or a comb (e.g., comb 212 (FIG. 2)) while carrier 300 is moving. Likewise, in some embodiments, the width of each tooth on carrier 300 (and/or carrier 300) may be constant. For example, the width may correspond to the maximum width of a tooth that allows the tooth to pass between two adjacent fingers (e.g., finger 208 and finger 210) and/or cutting members (e.g., cutting member 218 (FIG. 2) and cutting member 220 (FIG. 2)).

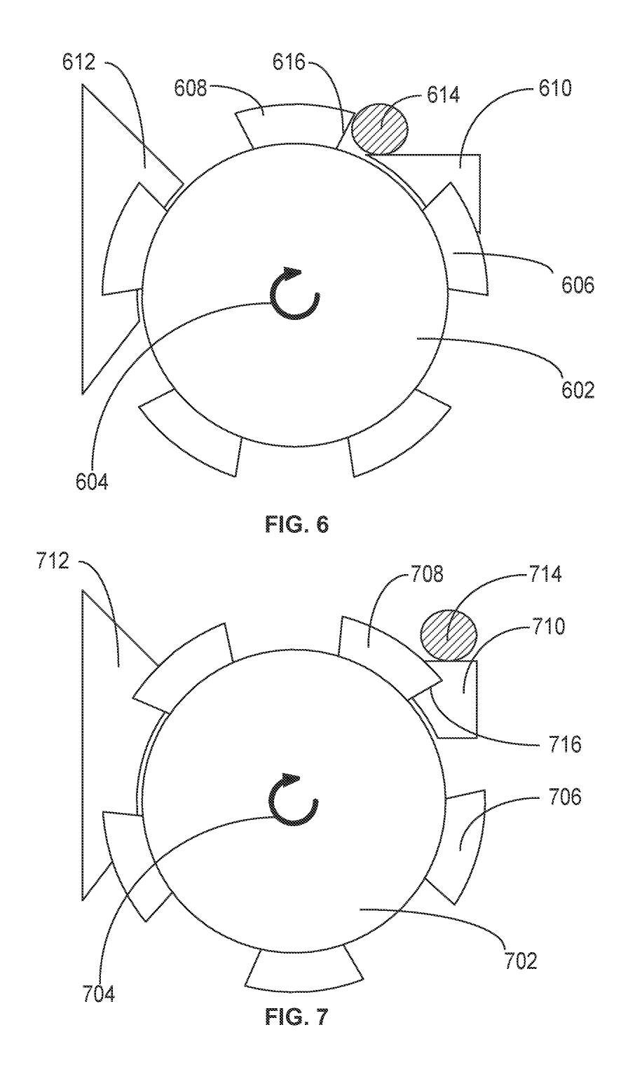

FIGS. 4-8 show illustrative examples of a shredding apparatus in which a blockage occurs that prevents the shredding apparatus from operating in a first direction, and the removal of the blockage by operating the shredding apparatus in a second direction. It should be noted that, in some embodiments, parts in one of FIGS. 4-8 may correspond to parts in another one of FIGS. 4-8. For example, FIG. 4 shows an illustrative cross-section of carrier 402, which, in some embodiments, may correspond to carrier 502 (FIG. 5), carrier 602 (FIG. 6) and/or carrier 702 (FIG. 7).

FIG. 4 shows an illustrative cross-section of a shredding apparatus. For example, in FIG. 4 may illustrate a cross-section of shredding apparatus 100 (FIG. 1) or shredding apparatus 200 (FIG. 2)). In FIG. 4, carrier 402 is moving in direction 404 (e.g., counter-clockwise). As carrier 402 moves in direction 404, the teeth (e.g., tooth 408 and tooth 406) extending from the edge of carrier 402 pass adjacent to cutting member 412 and finger 410. It should be noted that, in some embodiments, carrier 402 may be bounded by another cutting member and/or finger such that tooth 408 and tooth 406 pass between two adjacent cutting members and/or fingers.

As carrier 402 moves in direction 404, material may be shredded by a face of tooth 408 (e.g., corresponding to edge 416) as tooth 408 passes adjacent to cutting member 414. After tooth 408 passes adjacent to cutting member 414, material may be shredded by a face of tooth 406. For example, as carrier 402 moves in direction 404, the teeth extending from the edge of carrier 402 may shred material in series. Thus, as carrier 402 rotates in direction 404, material may continuously be shredded in series by the teeth. Carrier 402 may continue to move in direction 404 during which time material engaged by tooth 408 may be shredded between edge 416 (and/or a face associated with edge 416) and cutting member 412. However, while moving in direction 404, a blockage may occur, preventing the shredder from moving in direction 404.

FIG. 5 shows another illustrative cross-section of a shredding apparatus in which a blockage prevents the shredder from moving in a first direction. For example, in FIG. 5, carrier 502 is attempting to move in direction 504 (e.g., counter clockwise). As carrier 502 attempts to move in direction 504, the teeth (e.g., tooth 508 and 506) extending from the edge of carrier 502 pass adjacent to cutting member 512 and finger 510. However, blockage 514 is preventing carrier 502 from moving in direction 504. For example, carrier 502 (and/or a shredding apparatus of which carrier 502 is a part) is unable to generate the force necessary to shred blockage 514. Accordingly, carrier 502 is prevented from moving in direction 504.

FIG. 6 shows another illustrative cross-section of a shredding apparatus in which the shredding apparatus has pushed the blockage in a second direction. In FIG. 6, carrier 602 moves in direction 604 (e.g., clockwise), which is opposite to the direction at which carrier 602 moves in order to shred material. For example, upon determining that the shredding apparatus was no longer able to move carrier 602 in a first direction (e.g., due to a blockage), the shredding apparatus moved carrier 602 in direction 604 in order to clear the blockage. As carrier 602 moves in direction 604, the teeth (e.g., tooth 608 and 606) extending from the edge of carrier 602 pass adjacent to cutting member 612 and finger 610. Furthermore, while moving in direction 604, a face of tooth 608 (e.g., corresponding to edge 616) pushes blockage 614 in direction 604. For example, while the shredding apparatus may not have been able to generate the force necessary to shred blockage 614 while moving carrier 602 in a direction opposite to direction 604, the shredding apparatus can generate enough force to push blockage 614 to finger 610. As shown in FIG. 6, as the path of tooth 608 nears finger 610, tooth 608 pushes blockage 614 onto finger 610.

For example, a shredding apparatus (e.g., shredding apparatus 100 (FIG. 1)) may include carrier 602, which is movable in direction 604. As shown in FIG. 6, carrier 602 is a circular plate that rotates around an axis in direction 604. Furthermore, the shredding apparatus includes a tooth (e.g., tooth 608) extending from an edge of carrier 602 that pushes blockage 614 when carrier 602 is moving in the second direction. In some embodiments, the same tooth that is used for shredding material when the shredding apparatus is operating in a different direction (e.g., direction 504 (FIG. 5)) may be used to expel blockage 614 when the shredding apparatus is operating in direction 604.

The edge 616 is also angled relative to carrier 602, resulting in a contour for the face of tooth 608 corresponding to edge 616. For example, the face may be contoured to positively engage blockage 614. Such a contour may enhance the ability of tooth 608 to push blockage 614 and direct blockage 614 in direction 604. For example, the contour may create a surface that prevents blockage 614 from moving in a direction oblique to direction 604, or falling off of tooth 608, prior to blockage 614 contacting finger 610.

Finger 610 interacts with blockage 614 to move blockage 614 from tooth 608 as tooth 608 passes finger 610 in direction 604. For example, tooth 608 pushes blockage 614 in direction 604 until blockage 614 contacts finger 610. The contact with finger 610 then causes blockage 614 to move away from tooth 608. For example, in response to blockage 610, contacting finger 610 as carrier 602 is moving in direction 604, edge 616 may advance blockage 614 in a direction other than direction 604. For example, the contour of tooth 608 and the angle at which finger 610 contacts blockage 614 may impart a vector force onto blockage 614 that moves blockage 614 onto finger 610 and away from tooth 608 and carrier 602.

FIG. 7 shows another illustrative cross-section of a shredding apparatus in which the shredding apparatus has pushed the blockage onto a finger. For example, in FIG. 7, carrier 702 moves in direction 704 (e.g., clockwise), which is opposite to the direction at which carrier 702 moves in order to shred material. As carrier 702 moves in direction 704, the teeth (e.g., tooth 708 and 706) extending from the edge of carrier 702 pass adjacent to cutting member 712 and finger 710. Furthermore, while moving in direction 704, a face of tooth 708 (e.g., corresponding to edge 716) pushes blockage 714 in direction 704.

As shown in FIG. 7, a first portion of a tooth 708 (e.g., the top of tooth 708) may push the blockage as a second portion of tooth 708 (e.g., edge 716) passes finger 710 in direction 704. For example, as tooth 708 moves by finger 710, tooth 708 may continue to push blockage 714 (e.g., already positioned on top of finger 710 due to the initial contact between blockage 714 and finger 710). Furthermore, the continued pushing may advance blockage 714 along finger 710, increasing the distance between blockage 714 and carrier 702 and/or advancing blockage 714 towards a rejection passage (e.g., rejection passage 214 (FIG. 2)).

As shown, carrier 702 includes a plurality of teeth (e.g., tooth 708 and tooth 706). The plurality of teeth are arranged to push blockages 714 serially. For example, after tooth 706 passes finger 710 (and is no longer interacting with blockage 714), tooth 708 interacts with blockage 714. For example, tooth 708 may continue to move blockage 714 along finger 710. In some embodiments, tooth 708 may move blockage 714 towards and/or through a rejection passage (e.g., rejection passage 214 (FIG. 2)).

In some embodiments, the shredding apparatus may include a second carrier that is adjacent to, and shares a common axis with, carrier 702. The second carrier may include an additional tooth extending from the edge of the second carrier. The additional tooth and tooth 708 may move along respective parallel paths (e.g., in direction 704). Furthermore, the motion of the additional tooth on the second carrier may parallel the motion of tooth 708.

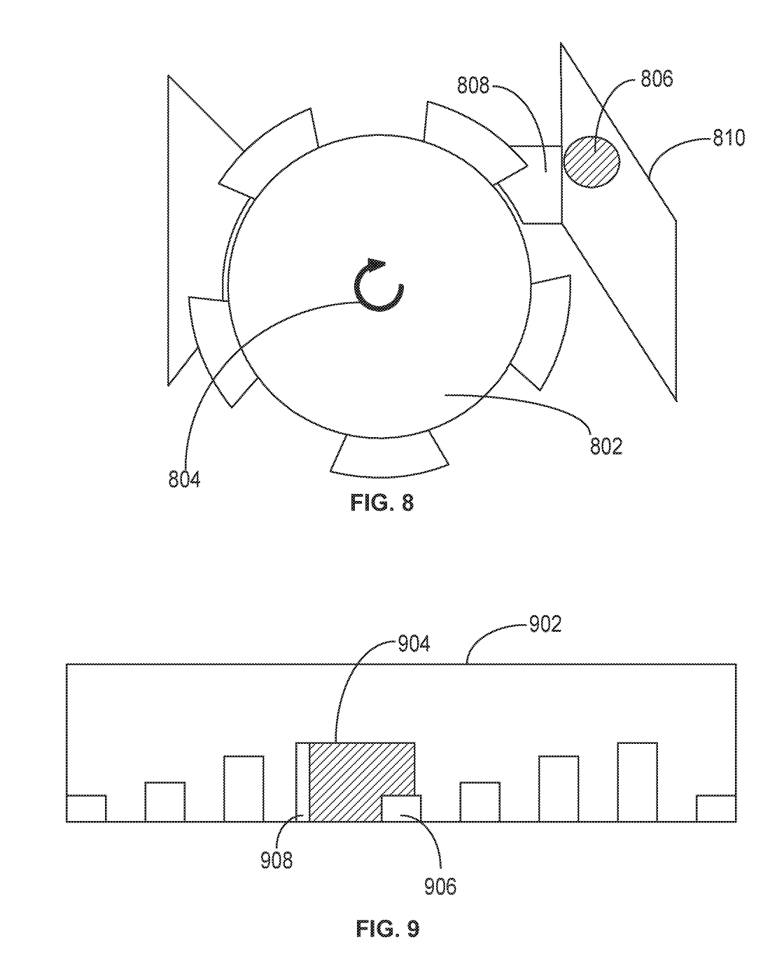

FIG. 8 shows another illustrative cross-section of the shredding apparatus in which the shredding apparatus has pushed a blockage into a rejection passage. In FIG. 8, as carrier 802 rotates in direction 804, blockage 806 has been pushed into rejection passage 810 (which in some embodiments may correspond to rejection passage 214 (FIG. 2)). For example, after being pushed across finger 808 (e.g., via a tooth extending from carrier 802), blockage 806 has entered rejection passage 810. Blockage 806 is now distanced from finger 808 (e.g., via gravity, user interaction, a conveyor belt, etc.) as it travels through rejection passage 810 and removed from the shredding apparatus.

FIG. 9 shows an illustrative example of a blockage being pushed into a rejection passage as the blockage from a point of view inside the rejection passage. In FIG. 9, blockage 904 is being pushed into the mouth of rejection passage 902 (which in some embodiments may correspond to rejection passage 214 (FIG. 2)) by tooth 908 (which in some embodiments may correspond to tooth 608 (FIG. 6)). As shown in FIG. 9, blockage 904 has not yet entered rejection passage 902 as a top portion of tooth 906 is still in front of blockage 904.

As tooth 908 continues to move (e.g., through a rotation on a carrier (e.g., carrier 602 (FIG. 6)), blockage 904 will be pushed closer to and/or inside rejection passage 902. For example, tooth 908 may succeed in pushing blockage 904 into rejection passage 902 at which point blockage 904 will be removed from the shredding apparatus. Alternatively, if blockage 904 is not pushed into rejection passage 902, a subsequent interaction with tooth 908 or tooth 906 may succeed in moving blockage 904 into rejection passage 902. For example, after passing between a plurality of fingers (not shown) and under a comb (not shown) tooth 906 and tooth 908 may continue on their respective paths. After making a rotation (e.g., on carrier 602 (FIG. 6)), tooth 906 and tooth 908 will again be positioned (e.g., blockage 904 will be positioned between tooth 906 and tooth 908 and rejection passage 902) to push blockage 904 into rejection passage 902.

FIG. 10 shows an illustrative example of a control system used to detect a blockage in the shredding apparatus. For example, in addition to an operator of the shredding apparatus performing manual inspections for blockages, the shredding apparatus may automatically detect blockages using sensors that detect whether or not the shredding apparatus is operating in a particular direction. FIG. 10 shows a generalized embodiment of control system 1000. Control system 1000 may receive data via input/output path 1002 from one or more sensors (e.g., that measure motion, electric current, vibrations, etc. indicative of whether or not the shredding apparatus is moving in a particular direction, is moving with a particular efficiency, and/or has encountered a blockage). I/O path 1002 may provide data to control circuitry 1004, which includes processing circuitry 1006 and storage 1008.

Control circuitry 1004 may be used to send and receive commands (e.g., to operate the shredding apparatus in a direction to expel blockages). Control circuitry 1004 may be based on any suitable processing circuitry such as processing circuitry 1006. Control circuitry 1004 may execute instructions for the shredding apparatus that are stored in memory (i.e., storage 1008). Specifically, control circuitry 1004 may be instructed to automatically begin operating the shredding apparatus in a direction to remove blockages in response to detecting a blockage.

A user may also send instructions to control circuitry 1004 (such as instructing the shredding apparatus to operate in a direction to expel blockages) using user input interface 1010, which may be any suitable user interface, such as a keypad, keyboard, etc. The user may also receive information from video interface 1012 and/or audio interface 1014, which may be provided as stand-alone devices or integrated with other elements of control system 1000. Video interface 1012, which may be any suitable interface capable of outputting video signals, such as a computer screen, may provide video alerts on the current status of the shredding apparatus (e.g., a direction in which the shredding apparatus is currently operating) and/or the occurrence of blockages. Likewise, audio interface 1014, which may be any suitable interface capable of outputting audio signals, such as an alarm sounder, speakers, and/or any other electromechanical device that produces sound, may provide audio alerts on the current status of the shredding apparatus (e.g., a direction in which the shredding apparatus is currently operating) and/or the occurrence of blockages.

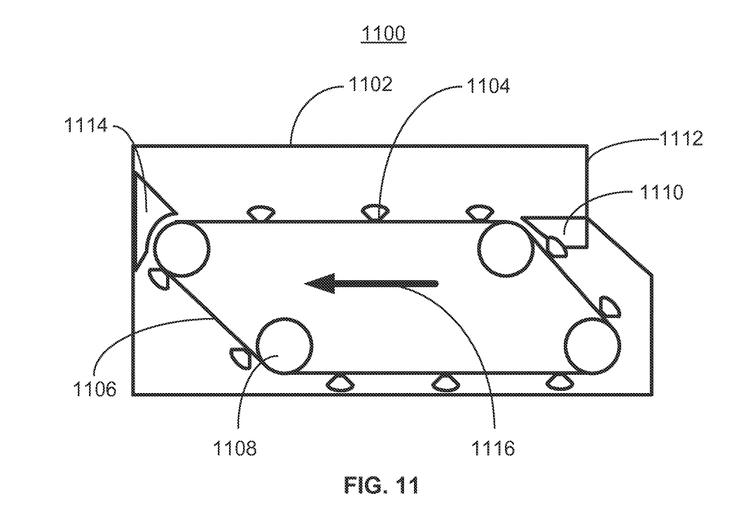

FIG. 11 shows an illustrative example of an embodiment of a shredding apparatus featuring a chain or belt used as a carrier. Shredding apparatus 1100 includes housing 1102. Within housing 1102, is carrier 1106. Carrier 1106 advances along a path directed by a plurality of rolling members (e.g., rolling member 1108). The plurality of rolling members may include gears, rollers, pulleys, or other suitable structures for directing a chain or belt.

While advancing along the path, a plurality of teeth (e.g., including tooth 1104) extending from carrier 1106 move adjacent to finger 1110 and cutting member 1114. While operating in direction 1116, shredding apparatus 1100 may shred material fed into shredding apparatus 1100 against cutting member 1114. In contrast, while moving in a direction opposite to direction 1116, shredding apparatus 1100 may push blockages across finger 1110 and through rejection passage 1112 (e.g., as discussed above in relation to FIGS. 4-8).

The above-described embodiments of the present invention are presented for purposes of illustration and not of limitation, and the present invention is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A shredding apparatus, the apparatus comprising:
a first carrier movable in a first direction and a second direction, wherein the second direction is opposite to the first direction;
a first tooth extending from an edge of the first carrier, wherein a first face of the first tooth shreds material when the first carrier is moving in the first direction and a second face of the first tooth pushes a blockage when the first carrier is moving in the second direction; and
a first finger, wherein the first finger interacts with the blockage to move the blockage from the first tooth as the first tooth passes the first finger in the second direction.

2. The apparatus of claim 1, wherein the first carrier is selected from a group consisting of a plate, a chain, and a belt.

3. The apparatus of claim 1, wherein the first carrier includes a plurality of teeth extending from the edge of the first carrier.

4. The apparatus of claim 1, further comprising:
a second carrier; and
a second tooth extending from an edge of the second carrier, wherein the second tooth and the first tooth move along respective parallel paths.

5. The apparatus of claim 4, wherein the second tooth on the second carrier has a position along its respective path that is offset from a position of the first tooth on the first carrier along its respective path.

6. The apparatus of claim 4, wherein the second tooth on the second carrier has a position along its respective path that is aligned with a position of the first tooth on the first carrier along its respective path.

7. The apparatus of claim 1, further comprising a second finger, wherein the second finger and the first finger are arranged in a row, and wherein at least one of the first finger or the second finger interacts with the blockage to move the blockage from the first tooth.

8. The apparatus of claim 7, wherein a first portion of the first tooth pushes the blockage as a second portion of the first tooth passes between the first finger and the second finger as the first carrier is moving in the second direction.

9. The apparatus of claim 7, wherein the first finger and the second finger are part of a comb.

10. The apparatus of claim 1, wherein the second face advances the blockage in a direction other than the second direction in response to the blockage contacting the first finger as the first carrier is moving in the second direction.

11. The apparatus of claim 1, wherein the second face is contoured to positively engage the blockage.

12. The apparatus of claim 1, further comprising a rejection passage, wherein:
the blockage passes into the rejection passage after the first finger moves the blockage from the first tooth; and
the rejection passage is accessible to the material while the first carrier moves in the first direction.

13. The apparatus of claim 12, wherein the second face forces the blockage towards the rejection passage.

14. A method of removing a blockage from a shredding apparatus, the method comprising:
moving a first carrier in a first direction, wherein moving the first carrier in the first direction causes a first tooth attached to the first carrier to shred material;
in response to detecting a blockage that prevents the first carrier from moving in the first direction, moving the first carrier in a second direction; and
while moving the first carrier in the second direction, pushing the blockage onto a first finger with the first tooth.

15. The method of claim 14, further comprising moving the blockage from the first tooth by interaction with the first finger as the first tooth passes the first finger in the second direction.

16. The method of claim 15, wherein the interaction comprises pushing the blockage with a first portion of the first tooth as a second portion of the first tooth passes the first finger in the second direction.

17. The method of claim 14, further comprising:
pushing the blockage along the first finger with the first tooth as the first tooth passes the first finger in the second direction; and
pushing the blockage along the first finger with a second tooth after the first tooth passes the first finger in the second direction.

18. The method of claim 14, further comprising pushing the blockage towards a rejection passage as the first tooth passes the first finger in the second direction.

19. The method of claim 14, further comprising passing the first tooth between the first finger and a second finger.

20. The method of claim 14, further comprising moving the blockage away from the first carrier with the first finger.

21. The method of claim 14, further comprising positively engaging the blockage with a contour of the first tooth as the first carrier moves in the second direction.

22. A shredding apparatus, the apparatus comprising:
a housing;
a plurality of circular plates in the housing, wherein the plurality of circular plates is rotatable around a common axis in a first direction, and in a second direction opposite to the first direction;
a plurality of fingers, wherein an interaction between the blockage and any one or more of the plurality of fingers moves the blockage away from a tooth of the plurality of teeth that is pushing the blockage as the tooth passes between the plurality of fingers in the second direction.

23. The apparatus of claim 22, wherein the plurality of teeth on a circular plate are angularly offset from the plurality of teeth on an adjacent circular plate.

24. The apparatus of claim 22, wherein the plurality of teeth on a circular plate are angularly aligned with the plurality of teeth on an adjacent circular plate.

25. The apparatus of claim 22, wherein the plurality of fingers are arranged in a row.

26. The apparatus of claim 22, wherein the interaction between the blockage and the any one or more of the plurality of fingers advances the blockage in a direction away from the axis.

27. The apparatus of claim 22, further comprising a rejection passage through which the blockage exits the housing.

28. The apparatus of claim 27, wherein the interaction between the blockage and the any one or more of the plurality of fingers advances the blockage in a direction towards the rejection passage.

29. The apparatus of claim 22, wherein each of the plurality of teeth is contoured to positively engage the blockage.
